(19) United States
(12) Patent Application Publication
(10) Pub. No.: US 2026/0150055 A1
(43) Pub. Date: May 28, 2026

(54) METHOD AND DEVICE FOR ALLEVIATING REFERENCE SIGNAL MEASUREMENT USING LOCATION INFORMATION OF TERMINAL

(71) Applicant: Samsung Electronics Co., Ltd., Gyeonggi-do (KR)

(72) Inventors: Byounghoon JUNG, Gyeonggi-do (KR); Sangyeob JUNG, Gyeonggi-do (KR)

(21) Appl. No.: 19/121,265

(22) PCT Filed: Jan. 9, 2024
(86) PCT No.: PCT/KR2024/000393

§ 371 Date: Apr. 15, 2025

(30) Foreign Application Priority Data
Jan. 18, 2023 (KR) 10-2023-0007587

(51) Int. Cl. H04W 52/02; H04L 5/00; H04W 28/02

(52) U.S. Cl. CPC H04W 52/0251; H04L 5/0048; H04W 28/0226; H04W 52/0245

(57) ABSTRACT

The present disclosure relates to a method for operating a terminal in a wireless communication system and an apparatus performing same, the method being characterized by comprising the steps of: receiving, from a base station of a non-terrestrial network, reference location information of a cell operated by the base station; determining whether a trigger condition for performing an operation to save power is satisfied on the basis of the reference location information; and in case that the trigger condition is satisfied, performing the operation to save power.

### TECHNICAL FIELD

The disclosure relates to operations of a UE and a base station in a wireless communication system and, specifically, to a method and an apparatus for measurement relaxation using location information of a UE in a non-terrestrial network system.

### BACKGROUND ART

G mobile communication technologies define broad frequency bands to enable high transmission rates and new services, and can be implemented not only in “Sub 6 GHz” bands such as 3.50 Hz, but also in “Above 60 Hz” bands referred to as mmWave including 28 GHz and 390 Hz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Lox Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 50 baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc. 50 performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO) multi-antenna transmission technologies such as array antennas and large-scale antennas, metamaterial-based lenses and antennas for improving coverage of terahertz band signals, high-dimensional space multiplexing technology using Orbital Angular Momentum (OAM) and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A method and devices for mobility support using location information a UE in the non-terrestrial network system are proposed, and in a case of the UE using the same, there is a need for a method for mobility support using measurement of a relative location between the UE and the network, unlike the conventional method based on the signal strength.

### DISCLOSURE

### Technical Problem

The disclosed embodiment provides a method and an apparatus for measurement relaxation using location information of a UE in a non-terrestrial network system in a wireless communication system.

### Technical Solution

An embodiment of the disclosure may provide an operation method of a terminal in a wireless communication system, the method including receiving, from a base station of a non-terrestrial network, reference location information of a cell operated by the base station, determining whether a trigger condition for performing an operation for power saving is satisfied, based on the reference location information, and in case that the trigger condition is satisfied, performing the operation for power saving.

In addition, an embodiment of the disclosure may provide a terminal of a wireless communication system, the terminal including a transceiver and a controller, wherein the controller is configured to receive, from a base station of a non-terrestrial network, reference location information of a cell operated by the base station, determine whether a trigger condition for performing an operation for power saving is satisfied, based on the reference location information, and in case that the trigger condition is satisfied, control the operation for power saving to be performed.

The technical subjects pursued in the disclosure may not be limited to the above-mentioned technical subjects, and other technical subjects which are not mentioned may be clearly understood from the following descriptions by those skilled in the art to which the disclosure pertains.

### Advantageous Effects

According to various embodiments of the disclosure, an apparatus and a method capable of reducing power consumption of a UE can be provided through a method for effectively deriving location of the UE and relaxing measurement in a wireless communication system.

### DESCRIPTION OF DRAWINGS

FIG. 1 illustrates a reference location and a distance threshold of coverage of each NTN network and a relative distance of a UE from the reference location of each network in an environment in which two non-terrestrial network (NTN) cells co-exist according to an embodiment of the disclosure.

FIG. 2 illustrates mobility of a UE moving within one NTN cell according to an embodiment of the disclosure.

FIG. 3 illustrates a UE which is stationary and not moving and an NTN base station for operating a network in a terrestrial network in an earth moving cell scheme according to an embodiment of the disclosure.

FIG. 4 illustrates a relationship among a moving satellite base station, a moving cell in a terrestrial network in which the corresponding base station provides a service, and a moving UE according to an embodiment of the disclosure.

FIG. 5 illustrates a location relationship of a UE in an NN cell according to an embodiment of the disclosure,

FIG. 6 illustrates an environment in which one or more terrestrial network (TNs) co-exist in a relatively large non-terrestrial network (NTN) in an environment in which a TN and an NTN co-exist, and a UE in the environment.

FIG. 7 illustrates acquiring information and triggering an event according to various embodiments of the disclosure.

FIG. 8 illustrates various distance thresholds for a reference signal measurement operation of a UE according to various embodiments of the disclosure.

FIG. 9 illustrates a structure of a base station according to an embodiment of the disclosure.

FIG. 10 illustrates a structure of a UE according to an embodiment of the disclosure.

### MODE FOR INVENTION

Hereinafter, exemplary embodiments of the disclosure will be described in detail with reference to the accompanying drawings. It should be noted that, in the accompanying drawings, the same or like elements are designated by the same or like reference signs as much as possible. In addition, a detailed description of known functions or configurations that may make the subject matter of the disclosure unclear will be omitted.

In describing embodiments set forth herein, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the present disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a. “unit”. Moreover, the elements and “units” may be implemented to reproduce one or more CPUs within a device or a security multimedia card.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to abase station. Furthermore, in the following description, LTE or LTE-A systems may be described by way of example, but the embodiments of the disclosure may also be applied to other communication systems having similar technical backgrounds or channel types. Examples of such communication systems may include the 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the disclosure may be applied to other communication systems through some modifications without significantly departing from the scope of the disclosure. Herein, it will be understood that each block of the flowchart illustrations, and combinations of blocks in the flowchart illustrations, can be implemented by computer program instructions.

In the following description of the disclosure, terms and names defined in 5GS and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards).

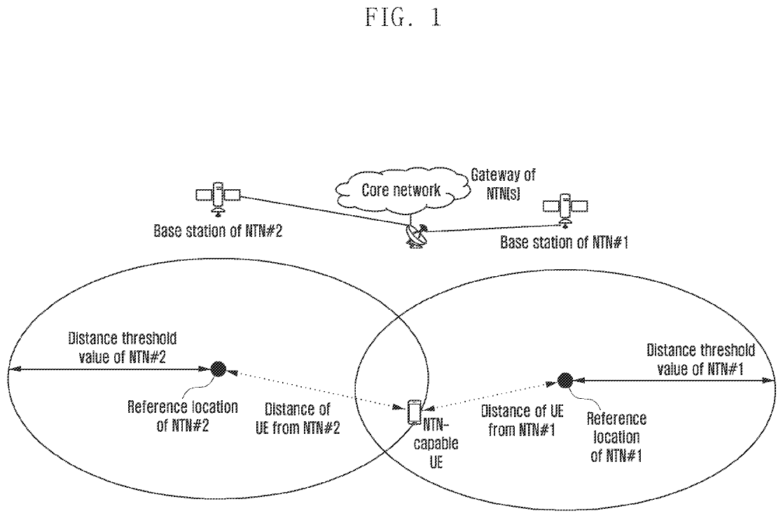

FIG. 1 illustrates a reference location and a distance threshold of coverage of each NTN network and a relative distance of a UE from the reference location of each network in an environment in which two non-terrestrial network (NTN) cells co-exist according to an embodiment of the disclosure.

According to FIG. 1, the UE may measure a distance between the UE and reference locations of different NTN cells, compare same, and access a relatively close NTN cell to perform wireless communication.

The UE may measure and compare a relative distance between the location of the UE and the reference locations of the respective NTN cells in real time. For example, the UE may measure, based on the location of the LIE, a relative distance (distance of UE from NTN #2) from a reference location of NTN #2, and may measure, based on the location of the UE, a relative distance (distance of UE from NTN #1) from a reference location of NTN #1.

The UE may perform a power saving operation in case that a condition is satisfied. For example, the UE may reduce power consumption by performing an operation of increasing a measurement period of a reference signal, such as configuring a longer measurement period of a reference signal transmitted by a base station of a cell compared to the existing measurement period, or suspending measurement of a reference signal of a cell.

As a condition needs to be satisfied in order for the UE performs the power saving operation, the following UE states and determination criteria can be considered.
A condition in which a UE in a radio resource control (RRC)-connected state is stationary
A condition in which a UE in an RRC idle mode or an inactive mode is stationary
A condition in which a UE in an RRC-connected state has low mobility
A condition in which a UE in an RRC idle mode or an inactive mode has low mobility
A condition in which a UE in an RRC-connected state is determined not to be near a cell edge (not-at-cell-edge)
A condition in which a UE in an RRC idle mode or an inactive mode is determined not to be near a cell edge (not-at-cell-edge)
A condition in which a UE in an RRC-connected state is determined to have a good service cell quality
A condition in which a UE in an RRC idle mode or an inactive mode is determined to have a good service cell quality
A condition in which a UE in an RRC-connected state is determined to have low mobility and not to be near a cell edge (not-at-cell-edge)
A condition in which a UE in an RRC idle mode or an inactive mode is determined to have low mobility and not to be near a cell edge (not-at-cell-edge)
A condition in which a UE in an RRC-connected state is determined to have low mobility and have a good serving cell quality
A condition in which a UE in an RRC idle mode or an inactive mode is determined to have low mobility and have a good serving cell quality

In case that one of the above-described conditions is satisfied, the UE can reduce power consumption by performing one or more of the following power saving operations.
The UE can reduce power consumption by configuring longer measurement periods of all reference signals, transmitted by a base station of a cell satisfying the condition, within the corresponding cell, compared to the existing measurement period.
The UE can reduce power consumption by configuring a longer measurement period of a reference signal satisfying the condition, transmitted by a base station of a cell satisfying the condition, within the corresponding cell, compared to the existing measurement period.
The UE can reduce power consumption by suspending measurement of all reference signals, transmitted by a base station of a cell satisfying the condition, within the corresponding cell.
The UE can reduce power consumption by suspending measurement of a reference signal satisfying the condition, transmitted by a base station of a cell satisfying the condition, within the corresponding cell.
The UE can reduce power consumption by configuring a longer measurement period for a specific reference signal satisfying the condition within a cell, e.g., all synchronization signal blocks (SSBs), all channel state information-reference signals (CSI-RSs), an SSB group configured by a base station, a CSI-RS group configured by the base station, an SSB configured by the base station, and a CSI-RS configured by the base station, compared to the existing measurement period.

Hereinafter, low mobility determination and reference signal measurement relaxation are first described.

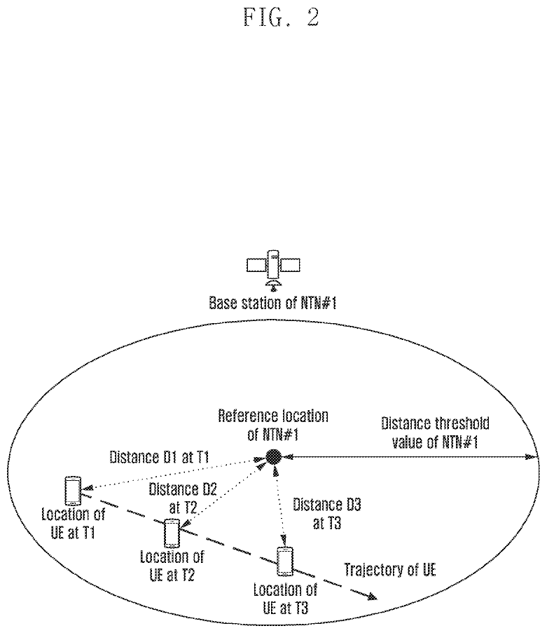

FIG. 2 illustrates mobility of a UE moving within one NTN cell according to an embodiment of the disclosure.

Referring to FIG. 2, the UE moves in a predetermined direction, and may measure a relative distance between the location of the UE and a reference location of an NTN cell for a predetermined time interval, e.g., a time interval of T1 to T3, along a moving trajectory, and record the same. In this case, the amount of change in the measured distance, e.g., |D2−D1|/(T2−T1) or |D3−D2|/(T3−T2), is the velocity of the UE, and in this case, in case that an interval between T1 and T2 is identical to an interval between T2 and T3, the UE is a UE for periodically measuring the distance.

In case that the velocity is equal to or below a predetermined level, the UE may determine that the corresponding UE has low mobility, and save power by relaxing a reference signal measurement criterion for radio resource measurement (RRM) in response to the determination. For example, in case that a UE determines that the corresponding UE has low mobility, the UE may increase a period of measuring a reference signal compared to a current period and reduce a reference signal measurement count per unit time so as to save power.

To this end, in order to determine that the UE has low mobility, the UE may measure or obtain a measured value, e.g., at least one of a relative distance value between the UE and a reference location of a cell, the amount of change in the relative distance value, or a relative velocity value obtained by dividing the amount of change in the relative distance value by a measurement time difference. The UE may perform an operation of performing determination by comparing at least one of the measured or obtained values with a reference threshold value, and to this end, a network may provide the UE with required information, e.g., a parameter value.

[Example Low Mobility 1] The UE may determine that a low mobility condition is satisfied in case that a value obtained by subtracting a reference distance (D_{ref}) from a distance (D) between a reference location of a measured cell, e.g., a serving cell, and the location of the UE is smaller than a threshold value (D_{searchDeltaP}) configured by a network, or in case that a value obtained by subtracting a reference distance (D_{ref}) from a distance (D) between a reference location of a measured serving cell and the location of the UE is smaller than a threshold value (D_{SearchDeltaP}) configured by a network for a time interval (T_{SearchDeltaP}) configured by the base station.

In this case, the reference distance (D_{ref}) may be reconfigured according to the following conditions.
a. In case that the UE selects or reselects a new cell, reconfigure the reference distance as a distance (D) between a reference location of a measured cell and the location of the UE
b. In case that the UE accesses a new cell or a reselected cell, reconfigure the reference distance as a distance (D) between a reference location of a measured cell and the location of the UE
c. In case that a value obtained by subtracting a distance (D) between a reference location of a currently measured cell and the location of the U E from the existing reference distance (D_{ref}) is greater than 0, reconfigure the reference distance as a currently measured distance (D)
d. In case that the condition has not been met for T_{SearchDeltaP} configured by the base station, reconfigure the reference distance as a currently measured distance (D)
e. In case that the condition has not been met at least more than one time for T_{SearchDeltaP} configured by the base station, reconfigure the reference distance as a currently measured distance (D)

TABLE 1
The relaxed measurement criterion for UE with low mobility is
fulfilled when:

| | |
|---|---|
| - | (D − D_{Ref}) < D_{SearchDeltaP} [symbol] |

Where:

| - | D = current distance value from the serving cell (m). | |
|---|---|---|
| - | D_{Ref} = reference D value of the serving cell (m), set as | |
| | follows: | |
| | - | After selecting or reselecting a new cell, or |
| | - | If (D_{Ref}−D) > 0, or |
| | - | If the relaxed measurement criterion has not been met for |
| | | T_{SearchDeltaP}: |
| | | - The UE shall set the value of D_{Ref} to the current D |
| | | value of the serving cell. |

[symbol]

indicates data missing or illegible when filed

[Example Low Mobility 2] The LUE may determine that a low mobility condition is satisfied in case that a value of |D−D_{Ref}| corresponding to a difference between a distance (D) between a reference location of a measured cell, e.g., a serving cell, and the location of the UE and a reference distance (D_{ref}) is smaller than a threshold value (D_{SearchDeltaP}) configured by a network, or in case that a value of |D−D_{Ref}| corresponding to a difference between a distance (D) between a reference location of a measured serving cell and the location of the UE and a reference distance (D_{ref}) is smaller than a threshold value (D_{SearchDeltaP}) configured by a network for a time interval (T_{SearchDeltaP}) configured by the base station.

In this case, the reference distance (D_{ref}) may be reconfigured according to the following conditions.
a. In case that the UE selects or reselects a new cell, reconfigure the reference distance as a distance (D) between a reference location of a measured cell and the location of the UE
b. In case that the UE accesses a new cell or a reselected cell, reconfigure the reference distance as a distance (D) between a reference location of a measured cell and the location of the UE
c. In case that a value obtained by subtracting a distance (D) between a reference location of a currently measured cell and the location of the FE from the existing reference distance (D_{ref}) is greater than 0, reconfigure the reference distance as a currently measured distance (D)
d. In case that a value of |D−D_{Ref}| corresponding to a difference between a distance (D) between a reference location of a serving cell and the location of the UE and a reference distance (D_{ref}) is greater than a threshold value (D_{SearchDeltaP}) configured by a network, reconfigure the reference location as a currently measured distance (D)
e. In case that the condition has not been met for T_{SearchDeltaP} configured by the base station, reconfigure the reference distance as a currently measured distance (D)
f. In case that the condition has not been met at least more than one time for T_{SearchDeltaP} configured by the base station, reconfigure the reference distance as a currently measured distance (D)

TABLE 2
The relaxed measurement criterion for UE with low mobility is
fulfilled when:

| | |
|---|---|
| - | \| D − D_{Ref} \| < D_{SearchDeltaP} [symbol] |

Where:

| - | D = current distance value from the serving cell (m). | |
|---|---|---|
| - | D_{Ref} = reference D value of the serving cell (m), set as | |
| | follows: | |
| | - | After selecting or reselecting a new cell, or |
| | - | If\| D_{Ref} − D \| D_{UpdateDeltaP} [symbol] or |
| | - | If the relaxed measurement criterion has not been met |
| | | for T_{SearchDeltaP}: |
| | | - The UE shall set the value of D_{Ref} to the current D value |
| | | of the serving cell. |

[symbol]

indicates data missing or illegible when filed

[Example Low Mobility 3] The UE may determine that a low mobility condition is satisfied in case that a value of |D−D_{Ref}| corresponding to a difference between a distance (D) between a reference location of a measured cell, e.g., a serving cell, and the location of the UE and a reference distance (D_{ref}) is smaller than a threshold value (D_{SearchDeltaP}) configured by a network, or in case that a value of |D−D_{Ref}| corresponding to a difference between a distance (D) between a reference location of a measured serving cell and the location of the UE and a reference distance (D_{ref}) is smaller than a threshold value (D_{SearchDeltaP}) configured by a network for a time interval (T_{SearchDeltaP}) configured by the base station.

In this case, the reference distance (D_{ref}) may be reconfigured according to the following conditions.
a. In case that the UE selects or reselects a new cell, reconfigure the reference distance as a distance (D) between a reference location of a measured cell and the location of the UE
b. In case that the UE accesses a new cell or a reselected cell, reconfigure the reference distance as a distance (D) between a reference location of a measured cell and the location of the UE
c. In case that a value obtained by subtracting a distance (D) between a reference location of a currently measured cell and the location of the UE from the existing reference distance (D_{ref}) is greater than 0, reconfigure the reference distance as a currently measured distance (D)
d. In case that a value of |D−D_{Ref}| corresponding to a difference between a distance (D) between a reference location of a serving cell and the location of the UE and a reference distance (D_{ref}) is greater than a threshold value (D_{SearchDeltaP}) configured by a network, reconfigure the reference location as a currently measured distance (D)
e. In case that the condition has not been met for T_{SearchDeltaP} configured by the base station, reconfigure the reference distance as a currently measured distance (D)
f. In case that the condition has not been met at least more than one time for T_{SearchDeltaP} configured by the base station, reconfigure the reference distance as a currently measured distance (D)
g. In case that TSearchDeltaP configured by the base station elapses, the reference distance is unconditionally reconfigured as a currently measured distance (D). In this configuration, the UE may obtain an instantaneous relative velocity (|D−D_{Ref}|/T_{SearchDeltaP}) by obtaining a difference between the value of the reference distance (D_{Ref}) and the currently measured distance (D) at each period configured by the base station, and may compare the same with a relative distance (D_{SearchDeltaP}) configured by the base station so as to compare the relative velocity and the velocity configured by the base station (D_{SearchDeltaP}/T_{SearchDeltaP}).

TABLE 3
The relaxed measurement criterion for UE with low mobility is
fulfilled when:

| | |
|---|---|
| - | \| D − D_{Ref} \| < D_{SearchDeltaP} [symbol] |

Where:

| - | D = current distance value from the serving cell (m). | |
|---|---|---|
| - | D_{Ref} = reference D value of the serving cell (m), set as | |
| | follows: | |
| | - | After selecting or reselecting a new cell, or |
| | - | If\| D_{Ref} − D \| > D_{UpdateDataP}, or |
| | - | If the relaxed measurement criterion has not been met |
| | | for T_{SearchDeltaP}: |
| | | - The UE shall set the value of D_{Ref} to the current D |
| | | value of the serving cell. |

[symbol]

indicates data missing or illegible when filed

[Example Low Mobility 4] The UE may determine that a low mobility condition is satisfied in case that a value (|D−D_{Ref}|/T_{SearchDeltaP}) obtained by dividing, by a time interval (T_{SearchDeltaP}) configured by the base station, a value of |D−D_{Ref}| corresponding to a difference between a distance (D) between a reference location of a measured cell, e.g., a serving cell, and the location of the UE and a reference distance (D_{ref}) is smaller than a velocity threshold value (V_{SearchDeltaP}) configured by a network.

In this case, the reference distance (Dre) may be reconfigured according to the following conditions.
h. In case that the UE selects or reselects a new cell, reconfigure the reference distance as a distance (D) between a reference location of a measured cell and the location of the UE
i. In case that the UE accesses a new cell or a reselected cell, reconfigure the reference distance as a distance (D) between a reference location of a measured cell and the location of the UE
j. In case that a value obtained by subtracting a distance (D) between a reference location of a currently measured cell and the location of the UE from the existing reference distance (D_{ref}) is greater than 0, reconfigure the reference distance as a currently measured distance (D)
k. In case that a value of |D−D_{Ref}| corresponding to a difference between a distance (D) between a reference location of a serving cell and the location of the UE and a reference distance (Dre) is greater than a threshold value (D_{SearchDeltaP}) configured by a network, reconfigure the reference location as a currently measured distance (D)
l. In case that a value (|D−D_{Ref}|/T_{SearchDeltaP}) obtained by dividing, by a time interval (T_{SearchDeltaP}) configured by the base station, a value of |D−D_{Ref}| corresponding to a difference between a distance (D) between a reference location of a serving cell and the location of the UE and a reference distance (D_{ref}) is greater than a velocity threshold value (V_{SearchDeltaP}) configured by a network, reconfigure the reference distance as a currently measured distance (D)
n. In case that the condition has not been met for T_{SearchDeltaP2} configured by the base station, reconfigure the reference distance as a currently measured distance (D)
n. In case that the condition has not been met at least more than one time for T_{SearchDeltaP2} configured by the base station, reconfigure the reference distance as a currently measured distance (D)
o. In case that TSearchDeltaP configured by the base station elapses, reconfigure the reference distance as a currently measured distance (D) unconditionally

TABLE 4
The relaxed measurement criterion for UE with low mobility is
fulfilled when:

| | |
|---|---|
| - | \| D − D_{Ref} \| / T_{SearchDeltaP} < V_{SearchDeltaP} [symbol] |

Where:

| - | D = current distance value from the serving cell (m). | |
|---|---|---|
| - | T_{SearchDeltaP} = fixed periodicity of measuring distance D | |
| | (sec). | |
| - | V_{SearchDeltaP} = velocity threshold for the relaxed | |
| | measurement criterion (m/sec). | |
| - | D_{Ref} = reference D value of the serving cell (m), set as | |
| | follows: | |
| | - | After selecting or reselecting a new cell, or |
| | | - The UE shall set the value of D_{Ref} to the current D |
| | | value of the serving cell. |

[symbol]

indicates data missing or illegible when filed

[Example Low Mobility 5] The UE may sequentially measure and store a distance between a reference location of a measured cell, e.g., a serving cell, and the location of the UE, and for example, in case that the most recently measured distance is indicated as the i-th distance value Dᵢ, the UE may compare the same with the immediately preceding measured distance value Dᵢ₋₁, and may determine that a low mobility condition is satisfied in case that a value ((|Dᵢ₋₁−Dᵢ|/T_{SearchDeltaP}) obtained by dividing, by a time interval (T_{SearchDeltaP}) configured by the base station, a value of |Dᵢ₋₁−Dᵢ| corresponding to a difference between the i-th distance value Dᵢ and the immediately preceding measured distance value Dᵢ₋₁ is smaller than a velocity threshold value (V_{SearchDeltaP}) configured by a network.

In this case, the corresponding time interval (T_{SearchDeltaP}) for sequentially measuring the distance may be configured by transmitting a signal to the UE by the base station.

TABLE 5

| The relaxed measurement criterion for UE with low mobility is | |
|---|---|
| fulfilled when: | |
| - | \| Dᵢ₋₁ − Dᵢ \| / T_{SearchDeltaP} < V_{SearchDeltaP} [symbol] |
| Where: | |
| - | Dᵢ = i-th measured distance value from the serving cell |
| | (m). |
| - | T_{SearchDeltaP} = fixed periodicity of measuring distance |
| | (sec). |
| - | V_{SearchDeltaP} = velocity threshold for the relaxed |
| | measurement criterion (m/sec). |

[symbol]

indicates data missing or illegible when filed

[Example Low Mobility 6] The UE may sequentially measure and store a distance between a reference location of a measured cell, e.g., a serving cell, and the location of the IE, and for example, in case that the most recently measured distance is indicated as the i-th distance value Dᵢ, the UE may compare the same with the immediately preceding measured distance value Dᵢ₋₁, may compare a value of |Dᵢ₋₁−Dᵢ| corresponding to a difference between the i-th distance value Dᵢ and the immediately preceding measured distance value Dᵢ₋₁ with a threshold value (D_{SearchDeltaP}) configured by a network, and may determine that a low mobility condition is satisfied in case that the value of |Dᵢ₋₁−Dᵢ| is smaller than the threshold value (D_{SearchDeltaP}).

In this case, the corresponding time interval (T_{SearchDeltaP}) for sequentially measuring the distance may be configured by transmitting a signal to the UE by the base station.

TABLE 6

| The relaxed measurement criterion for UE with low mobility is | |
|---|---|
| fulfilled when: | |
| - | \| Dᵢ₋₁ − Dᵢ \| < D_{SearchDeltaP} [symbol] |
| Where: | |
| - | Dᵢ = i-th measured distance value from the serving cell |
| | (m). |
| - | T_{SearchDeltaP} = fixed periodicity of measuring distance |
| | (sec). |
| - | V_{SearchDeltaP} = velocity threshold for the relaxed |
| | measurement criterion (m/sec). |

[symbol]

indicates data missing or illegible when filed

Referring to FIG. 2, a criterion for determining whether or not a UE satisfies a low mobility condition according to the amount of change in a relative location difference of the UE which moves with respect to a reference location of a fixed NTN cell has been proposed.

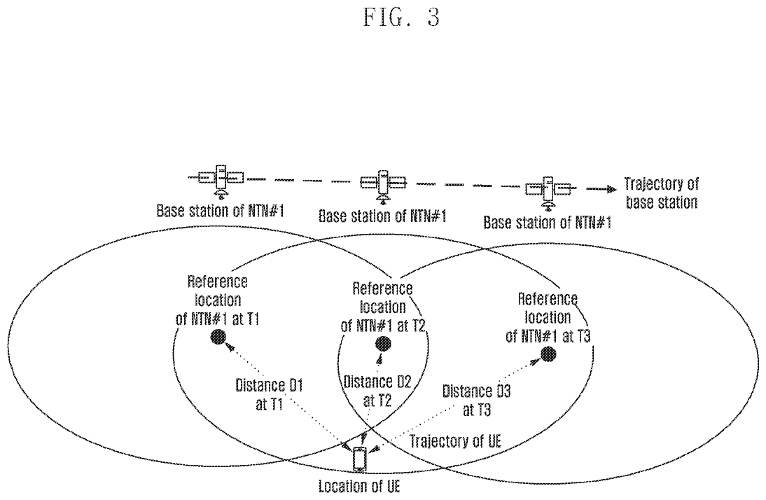

FIG. 3 illustrates a UE which is stationary and not moving and an NTN base station for operating a network in an earth moving cell scheme (a scheme in which the location of a cell providing a service while moving is also changed) according to an embodiment of the disclosure.

Referring to FIG. 3, in an environment in which the UE is not moving but the base station moves and a reference location of a cell provided by the base station is also moved, a situation in which relative distance D between the reference locations of the UE and the base station also has different values such as D1, D2, and D3 according to measured time points T1, T2, and T3 is illustrated. In consideration of terrestrial moving cell NTN #1, in case that the UE is not moving, the velocity of the base station may be indicated through a relatively changing distance, and the velocity of the base station may be represented in the form of (|D₂−D₁|/T_{SearchDeltaP}) obtained by dividing, by a time interval in case that the time interval in which the UE measures a relative distance is T_{SearchDeltaP}, a difference between two different distance values measured in the corresponding time interval.

In other words, in such an environment, the velocity of the base station may be indicated by a constant value represented by a difference between distances measured by a stationary UE, e.g., (|D₂−D₁|/T_{SearchDeltaP}) V_{NTN_gNB}, and whether the UE moves at the relatively same velocity as the terrestrial moving cell or moves fast from the cell can be determined through comparison between the constant value and a value actually measured by the UE.

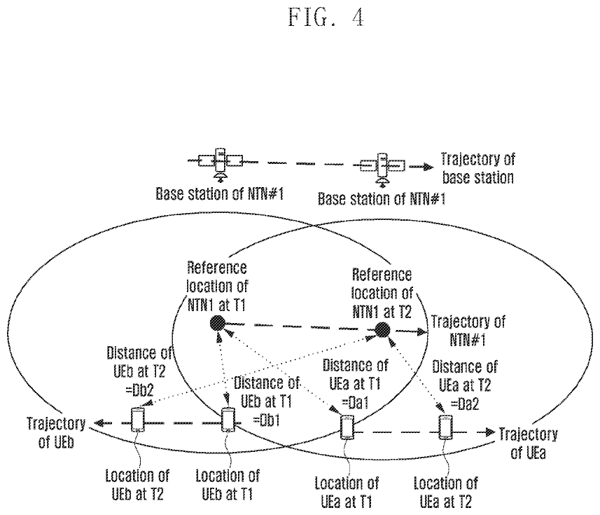

FIG. 4 is referred to for a more detailed description. FIG. 4 illustrates a relationship among a moving satellite base station, a moving cell in a terrestrial network in which the corresponding base station provides a service, and a moving UE according to an embodiment of the disclosure.

Referring to FIG. 4, a moving satellite base station, changing reference locations of terrestrial moving cell NTN #1 in which the corresponding base station provides a service, UEa moving in the relatively same direction as terrestrial moving cell NTN #1, and UEb moving in a relatively different direction from terrestrial moving cell NTN #1 may be identified. In FIG. 4, the directions of two UEs are opposite from each other but it is assumed that the moving velocities are almost similar.

Referring to FIG. 4, in a case of UEa, the relative velocity with terrestrial moving cell NTN #1 may be represented by (|Dₐ₂−Dₐ₁|/T_{SearchDeltaP}), and in a case of UEb, the relative velocity with terrestrial moving cell NIN #1 may be represented by (|D_{b2}−D_{b1}|/T_{SearchDeltaP}). In addition, it is identified that the relative velocity (|Dₐ₂−Dₐ₁|/T_{SearchDeltaP}) of UEa is smaller than the relative velocity (|D_{b2}−D_{b1}|/T_{SearchDeltaP}) Of UEb. In case that the relative velocities are compared with the velocity (|D₂−D₁|/T_{SearchDeltaP}) of territorial Moving cell NTN #1 illustrated in FIG. 3, it is assumed that the velocity is smaller than the relative velocity (|D_{b2}−D_{b1}|/T_{SearchDeltaP}) of UEb and is greater than the relative velocity (|Dₐ₂−Dₐ₁|/T_{SearchDeltaP}) of UEa.

In a case of a terrestrial moving cell along a non-terrestrial base station moving in the air, comparing the relative velocity as in FIG. 4 in order to determine whether a UE has a longer residence time in the corresponding cell may be an appropriate method. In this situation, as a solution to reference signal measurement relaxation and power saving therethrough, various solutions described in FIG. 2 may be used the same by using reference locations configured by the base station and various threshold values. The low mobility determination condition and the reference signal measurement method therethrough described through FIG. 2 can be applied the same.

In various embodiments of the disclosure, the low mobility determination condition may be used as necessary in case that the UE operates in various modes such as an idle mode, an RRC_Idle mode, an inactive mode, an RRC_Inactive mode, a connected mode, or an RRC-connected mode, and mobility of the UE can be determined.

Through this determination, the UE may be determined to have a relatively low probability of being out of cell in case that having low mobility, and accordingly, power can be saved by changing a channel measurement frequency such as increasing an RRM measurement period or increasing a radio link monitoring (RLM) monitoring period.

In various embodiments of the disclosure, the low mobility determination condition may be used to determine whether the UE is a UE that does not almost move (a stationary UE) by using a smaller threshold value in case that the UE operates in various modes such as an idle mode, an RRC Idle mode, an inactive mode, an RRC_Inactive mode, a connected mode, or an RRC-connected mode.

Through this determination, the UE may be determined to have a relatively low probability of being out of cell in case that having barely any mobility, and accordingly, power can be saved by changing a channel measurement frequency such as increasing an RRM measurement period or increasing a radio link monitoring (RLM) monitoring period.

Hereinafter, according to various embodiments of the disclosure, a method for determining low mobility and a reference signal measurement relaxation method in a case in which the UE is not at the cell edge (not-at-cell edge) are described.

[Example not-at-Cell-Edge]

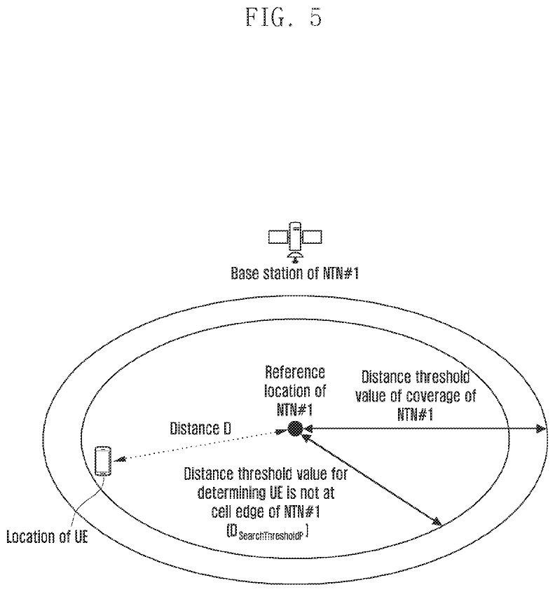

FIG. 5 illustrates a location relationship of a UE in an NTN cell according to an embodiment of the disclosure, Referring to FIG. 5, the UE belonging to NTN cell #1 compares distance D between a reference location of the cell and the location of the UE with distance threshold value DSearchThresholdP from a reference location of a cell, that can be configured by the cell. In case that distance D of the UE has a value smaller than the distance threshold value, it may be determined that the UE is located at the center of the cell.

TABLE 7

```
The relaxed measurement criterion for UE not at cell edge is
fulfilled when:
  - D < D_{SearchThresholdP}, and,
Where:
  - D = current distance value of the serving cell (m).
```

In various embodiments of the disclosure, a condition for determining whether the UE is located at the center of a cell may be used as necessary in case that the UE operates in an idle mode, an RRC_Idle mode, an inactive mode, an RRC_Inactive mode, a connected mode, or an RRC-connected mode, and a relative position in the cell of the UE can be determined.

In various embodiments of the disclosure, the determination condition may be used to determine whether the UE is present at the location in which the LUE can stably receive a service from the cell. This condition may be used as necessary in case that the UE operates in various modes such as an idle mode, an RRC_Idle mode, an inactive mode, an RRC_Inactive mode, a connected mode, or an RRC-connected mode, and a relative location in the cell of the LIE can be determined.

Through the determination, in case that it is determined that the UE is located at the center of the cell, the UE may be determined to have a relatively low probability of being out of cell, and accordingly, power can be saved by changing a channel measurement frequency such as increasing an RRM measurement period or increasing a radio link monitoring (RLM) monitoring period.

The UE may perform the operation for power saving in case that one or more determination conditions are satisfied according to the configuration.

In various embodiments of the disclosure, the terminal may receive a configuration from the base station so that whether one or more of the examples, [Example Low Mobility 1] to [Example Low Mobility 6], proposed above to determine whether the LIE has low mobility, are simultaneously satisfied is determined.

For example, the LUE may receive a configuration of one or more of the examples, [Example Low Mobility 1] to [Example Low Mobility 6], proposed above to determine whether the UE has low mobility. In addition, the UE may also receive a configuration from the base station so as to determine whether a condition according to a change in a reception signal strength which can be determined through a reference signal received from the base station is satisfied. For example, the UE may receive a configuration from the base station so as to determine whether the following conditions (the location of the UE and the reception signal strength) are simultaneously satisfied.

TABLE 8
[Example Low Mobility S]

The relaxed measurement criterion for UE with low mobility is
fulfilled when:

| | |
|---|---|
| - | (Srxlev_{Ref} − Srxlev) < S [symbol] |

Where:

| - | Srxlev = current Srxlev value of the serving cell (dB). | |
|---|---|---|
| - | Srxlev_{Ref} = reference Srxlev value of the serving cell (dB), | |
| | set as follows: | |
| | - | After selecting or reselecting a new cell, or |
| | - | If (Srxlev − Srxlev_{Ref}) > 0, or |
| | - | If the relaxed measurement criterion has not been |
| | | met for T_{SearchDeltaP} [symbol] |

| | |
|---|---|
| - | The UE shall set the value of Srxlev_{Ref} to the current Srxlev |
| | value of the serving cell. |

[symbol]

indicates data missing or illegible when filed

Here, SSearchDeltaP and TSearchDeltaP indicate a reception signal strength threshold value and a reception signal measurement time, respectively, which are configured by the base station.

In another embodiments of the disclosure, the UE may determine whether at least one of the series of conditions configured by the base station, e.g., [Example Low Mobility 1] to [Example Low Mobility 6] and [Example Low Mobility S], and in case that at least one of the conditions is satisfied, the UE may determine to be in a low mobility state, and may perform an operation for power saving.

In case that the mobility of the UE is determined in consideration of both the reception signal strength and the location of the UE, the mobility can be more accurately determined, compared to a determination criterion in which only one of the reception signal strength and the location of the UE is considered.

In addition, in various embodiments of the disclosure, the UE may be configured to not only determine whether the example, [Example not-at-cell-edge], proposed above to determine whether the UE, belongs to the location closer to the cell center, is satisfied but also determine a condition according to a change in the reception signal strength which can be determined through the reference signal received from the base station is satisfied. For example, the UE may receive a configuration from the base station so as to determine whether the following conditions (the location of the UE and the reception signal strength) are simultaneously satisfied.

TABLE 9
[Example not-at-cell-edge S]

The relaxed measurement criterion for UE not at cell edge is
fulfilled when:
- Srxlev > S [symbol] and,
- Squal > S [symbol] if S [symbol] is configured,
Where:
- Srxlev = current Srxlev value of the serving cell (dB).
- Squal = current Squal value of the serving cell (dB). [symbol]
indicates data missing or illegible when filed

Here, SSearchDeltaP and SSearchDeltaQ indicate threshold values of reference signal received power (RSRP) corresponding to a reception signal strength and a reference signal received quality (RSRQ) value corresponding to a, reception signal quality, respectively, which are configured by the base station.

In case that whether the UE is located close to the cell center or whether a serving cell quality is good is determined in consideration of both the reception signal strength and the location of the UE, it can be more accurately determined, compared to a determination criterion in which only one of the reception signal strength and the location of the UE is considered.

In addition, in various embodiments of the disclosure, the UE may receive a configuration from the base station so as to determine both whether the E has low mobility and whether the UE belongs to the location close to the cell center. For example, the UE may receive a configuration from the base station to determine both whether at least one or one or more of the above-proposed examples, [Example Low Mobility 1] to [Example Low Mobility 6] and [Example Low Mobility S] is satisfied and whether at least one or one or more of [Example not-at-cell-edge] and [Example not-at-cell-edge S] is satisfied.

In case that both whether the UT has low mobility and Whether the UE is located close to the cell center are determined in consideration of both the reception signal strength and the location of the UE, it can be more accurately determined, compared to a determination criterion in which only one condition is considered.

In various embodiments of the disclosure, the UE may receive a configuration so as to determine not only the condition in the example, [Example not-at-cell-edge], proposed above to determine whether the quality of a serving cell is good, but also the condition according to a change in the reception signal strength which can be determined through the reference signal received from the base station. For example, the UE may receive a configuration from the base station so as to determine whether the following conditions (the location of the UE and the change in the reception signal strength) are simultaneously satisfied.

TABLE 10
The relaxed measurement criterion of good serving cell quality for RLM is fulfilled when the downlink
radio link quality on the configured RLM-RS resource is evaluated to be better than the threshold
Q [symbol] XdB, wherein

| | |
|---|---|
| - | Q [symbol] is specified in below tables |
| - | X is the parameter offset in goodServingCellEvaluationRLM. |

The relaxed measurement criterion of good serving cell quality for BFD is fulfilled when the downlink
radio link quality on the configured BFD-RS resource is evaluated to be better than the threshold
Q [symbol] XdB, wherein

| | |
|---|---|
| - | Q [symbol] is specified in below tables |
| - | X is the parameter offset in goodServingCellEvaluationBFD. |
| | The threshold Q [symbol] is defined as the level at which the downlink radio link quality can be received |

with significantly higher reliability than at Q [symbol] and shall correspond to the in-sync block error rate
(BLER [symbol] ) as defined in Table 8.1.1-1. For SSB based radio link monitoring, Q [symbol] is derived based on the
hypothetical PDCCH transmission parameters listed in Table 8.12.1-2. For CSI-RS based radio link
monitoring, Q [symbol] is derived based on the hypothetical PDCCH transmission parameters listed in Table
8.1.3.1-2. [symbol]
indicates data missing or illegible when filed

TABLE 11

| Configuration | BLERₒᵤₜ | BLERᵢₙ |
|---|---|---|
| 0 | 10% | 2% |

Table 11 shows out-of-synchronization (out of sync) and in-synchronization (in sync) block error rates (BLERs).

TABLE 12

| | Value for BLER |
|---|---|
| Attribute | Configuration #0 |
| DCI payload size | 1-0 |
| Number of control OFDM symbols | 2 |
| Aggregation level (CCE) | 4 |
| Ratio of hypothetical PDCCH | 0 dB |
| RE energy to average | |
| SSS RE energy | |
| Ratio of hypothetical PDCCH | 0 dB |
| DMRS energy to average | |
| SSS RE energy | |
| Bandwidth (PRBs) | 24 |
| Sub-carrier spacing (kHz) | SCS of the active DL BWP |
| DMRS precodes granularity | REG bundle size |
| REG bundle size | 6 |
| CP length | Normal |
| Mapping from REG to CCE | Distributed |

TABLE 13

| | Value for BLER |
|---|---|
| Attribute | Configuration #0 |
| DCI payload size | 1-0 |
| Number of control OFDM symbols | 2 |
| Aggregation level (CCE) | 4 |
| Ratio of hypothetical PDCCH RE | 0 dB |
| energy to average CSI-RS | |
| RE energy | |
| Ratio of hypothetical PDCCH | 0 dB |
| DMRS energy to average | |
| CSI-RS RE energy | |
| Bandwidth (PRBs) | 48 |
| Sub-carrier spacing (kHz) | SCS of the active DL BWP |
| DMRS precodes granularity | REG bundle size |
| REG bundle size | 6 |
| CP length | Normal |
| Mapping from REG to CCE | Distributed |

Tables 12 and 13 show PDCCH transmission parameters for in-sync evaluation.

In various embodiments of the disclosure, the UE may receive a configuration from the base station to determine whether one or more of the conditions of the examples [Example Low Mobility 1] to [Example Low Mobility 6], proposed above to determine whether the UE has very low mobility, and the condition according to the change in the reception signal strength are simultaneously satisfied.

For example, the UE may receive a configuration so as to determine not only one or more conditions of the examples, [Example Low Mobility 1] to [Example Low Mobility 6], proposed above to determine whether the IE has low mobility, but also the condition according to the reception signal strength which can be determined through the reference signal received from the base station. For example, the UE may receive a configuration from the base station so as to determine whether the following conditions (the mobility condition and the condition according to the change in the reception signal strength) are simultaneously satisfied.

TABLE 14
[Example Stationary [symbol] ]

The relaxed measurement criterion for a stationary UE is met when:

| | |
|---|---|
| - | (SS-RSRP [symbol] − SS-RSRP) < S [symbol] |

Where:

| - | SS-RSRP = currentL3 RSRP measurement of the PCell based on SSB (dB). | |
|---|---|---|
| - | SS-RSRP [symbol] = reference SS-RSRP value of the PCell (dB), set as follows: | |
| | - | at the end of RRC reconfiguration procedure as specified in 5.3.5.3, when |
| | | rrm-MeasRelaxationReportingConfig is included in the RRCReconfiguration message: or |
| | - | after MAC successfully completes a Random Access procedure after applying a |
| | | reconfigurationWithSync in spCellConfig while stationary criterion is configured; or |
| | - | if (SS-RSRP − SS-RSRP [symbol] ) > 0; or |
| | - | if the relaxed measurement criterion has not been met for T [symbol] |

| | |
|---|---|
| - | UE shall set the value of SS-RSRP [symbol] to the current SS-RSRP value of the serving |

cell. [symbol]
indicates data missing or illegible when filed

Here. S_{SearchDeltaP-StationaryConnected} and T_{SearchDeltaP-StationaryConnected} indicate a reception signal strength threshold value and a reception signal measurement time, respectively, configured by the base station.

The synchronization signal-reference signal received power (SS-RSRP) may be an RSRP measurement value of a synchronization signal (SSB), measured by the UE.

The SS-RSRP may, be substituted by a RSRP measurement value of a CSI-RS, measured by the UE.

TABLE 15
[Example Stationary S, CSI-RS]

The relaxed measurement criterion for a stationary UE is met when:

| | |
|---|---|
| - | (CSI-RSRP [symbol] − CSI-RSRP) < S [symbol] |

Where:

| - | CSI-RSRP = current L3 RSRP measurement of the PCell based on CSI-RS (dB). | |
|---|---|---|
| - | CSI-RSRP [symbol] = reference CSI-RSRP value of the PCell (dB), set as follows: | |
| | - | at the end of RRC reconfiguration procedure as a specified in 5.3.5.3, when |
| | | rrm-MeasRelaxtionReportingConfig is included in the RRCReconfiguration message; or |
| | - | after MAC successfully completes a Random Access procedure after applying a |
| | | reconfigurationWithSync in spCellConfig while stationary criterion is configured; or |
| | - | if (CSI-RSRP − CSI-RSRP [symbol] ) > 0; or |
| | - | if the relaxed measurement criterion has not been met for T [symbol] |

| | |
|---|---|
| - | UE shall set the value of CSI -RSRP [symbol] to the current CSI -RSRP value of the |

serving cell. [symbol]
indicates data missing or illegible when filed

In various embodiments of the disclosure, the UE may determine whether at least one condition among the series of conditions configured by the base station, e.g. [Example Low Mobility 1] to [Example Low Mobility 6], [Example Stationary S], and [Example Stationary S, CSI-RS], is satisfied, determine, in case that satisfied, that the UE is in a low mobility state, and perform an operation for power saving.

In various embodiments of the disclosure, the UE may be a UE having specificity, e.g., a reduced capability (RedCap) UE having constraints on the performance.

In various embodiments of the disclosure, the configuration of the threshold values and the conditions may be a radio signal transmitted to the UE by the base station, e.g., an RRC signal, a medium access control (MAC) signal, or a physical (PHY) signal.

In various embodiments of the disclosure, the UE may be terrestrial network UE (TN UE) or a non-terrestrial network UE (NTN UE) accessing a satellite, etc., and the base station may be a terrestrial base station (TN gNB) or a non-terrestrial network base station (NTN gNB) such as a satellite, etc.

The serving cell mentioned in various embodiments of the disclosure may be an adjacent cell or a target cell, and may be a group of cells. The serving cell in the conditions configured in the embodiments may be also substituted by an adjacent cell, a target cell, or a group of cells.

Hereinafter, location-based RRM on/off/relax according to various embodiments of the disclosure is described.

In an environment in which one or more terrestrial networks and non-terrestrial base stations co-exist, in case that a condition according a relative distance from reference locations of cells configured by the base station is satisfied, for power saving, the UE may increase a period of reference signal measurement, turn off the period, reduce the period of the reference signal measurement for mobility support, or turn on the period if it is turned off.

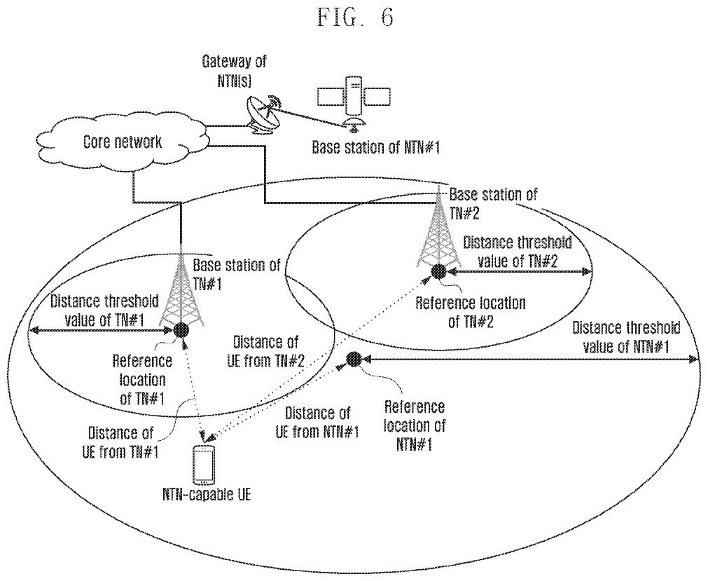

FIG. 6 illustrates an environment in which one or more terrestrial network (TNs) co-exist in a relatively large non-terrestrial network (NTN) in an environment in which a TN and an NTN co-exist, and a UE in the environment.

Referring to FIG. 6, the UE may be a UE having NTN usage capability which can use both the TN and the NTN, and gNBs corresponding to transmission and reception terminals of the TN and the NTN are wiredly/wirelessly connected to a core network. The gNBs have physical reference locations in which the corresponding gNB provides a service. The reference locations may be indicated as below.
Reference location of area (NTN #1 cell) of service provided by NTN #1 satellite base station:

$${R}_{Ref}^{NTN 1}$$

Reference location of area (TN #1 cell) of service provided by TN #1 terrestrial base station:

$${R}_{Ref}^{TN 1}$$

Reference location of area (TN #2 cell) of service provided by TN #2 terrestrial base station:

$${R}_{Ref}^{TN 1}$$

In addition, each of the base stations may have the following distance threshold from each reference location drawing the edge of a service area according to a physical location difference.
Distance threshold value of NTN #1 cell:

$${D}_{Thr}^{NTN 1}$$

Distance threshold value of TN #1 cell:

$${D}_{Thr}^{TN 1}$$

Distance threshold value of TN #2 cell:

$${D}_{Thr}^{TN 2}$$

Alternatively, each of the cells may indicate a service area in other methods, the service area may be illustrated in the form of polygon having a list of reference locations as the vertices thereof, and may have the following list of reference locations.
Service area vertex reference location list of NTN #cell:

$${R}_{edge}^{MTN 1} ( 1 , 2 , … , k ) , {R}_{edge 2}^{NTN 1} \text{?} … , {R}_{edge i}^{NTN 1}$$

$$\text{?} \text{indicates text missing or illegible when filed}$$

Service area vertex reference location list of TN #1 cell:

$${R}_{edge 1}^{TN 1} ( 1 , 2 , … , k ) , {R}_{edge 2}^{TN 1} \text{?} … , {R}_{edge i}^{TN 1}$$

$$\text{?} \text{indicates text missing or illegible when filed}$$

Service area vertex reference location list of TN #2 cell:

$${R}_{edge 1}^{TN 2} ( 1 , 2 , … , k ) , {R}_{edge 2}^{TN 2} \text{?} … , {R}_{edge i}^{TN 2}$$

$$\text{?} \text{indicates text missing or illegible when filed}$$

In this environment, the UE may compare the measured location of the UE and the reference location of each of the cells, and may have each distance as follows.
Distance between UE and reference location of NTN #1 cell:

$${d}_{UE}^{NTN 1}$$

Distance between UE and reference location of TN #1 cell:

$${d}_{UE}^{TN 1}$$

Distance between UE and reference location of TN #2 cell:

$${d}_{UE}^{TN 2}$$

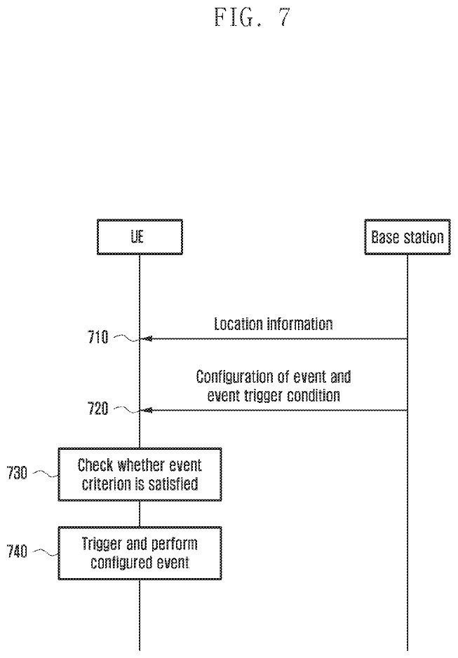

FIG. 7 illustrates acquiring information and triggering an event according to various embodiments of the disclosure.

Referring to FIG. 7, location information (e.g., reference locations of a terrestrial network and a non-terrestrial network and reference locations and distance threshold values by which service areas can be inferred) may be transmitted in the form of a list to the UE from the base station through the following signal (operation 710).
For example, reference locations of a terrestrial network and/or a non-terrestrial network and/or reference locations or distance threshold values by which services areas can be inferred may be transmitted through a unicast signal transmitted from a serving base station to which a UE is connected to the corresponding UE. For example, as a type of an information element of an RRC signal, the information may be included in an information signal such as reportconfigNR and transmitted. Alternatively, the information may be included in a MAC signal or a PHY signal and transmitted.
For example, the reference locations of the terrestrial network and/or the non-terrestrial network and/or the reference locations or the distance threshold values by which the service areas can be inferred may be included in a broadcast signal transmitted from a serving base station to which a UE is connected to UEs e.g., a system information block (SIB) signal, and transmitted.

For example, the reference locations of the terrestrial and/or non-terrestrial network and/or the reference locations or the distance threshold values by which the service areas can be inferred may be included in a groupcast signal transmitted from a serving base station to which a UE is connected to UEs, e.g., a system information block (SIB) signal, and transmitted.
For example, the reference locations of the terrestrial and/or non-terrestrial network and/or the reference locations or the distance threshold values by which the service areas can be inferred may be included in a broadcast signal transmitted from a base station to which a UE is connected to UEs, e.g., a system information block (SIB) signal, and transmitted.

The UE may determine, based on the location information and an event trigger condition, whether an event condition is satisfied (operation 730). In addition, in case that the event trigger condition is satisfied, the UE may perform the corresponding event operation (operation 740). For example, as the location of the UE changes, whether or not a base station belonging to the terrestrial network and the non-terrestrial network can provide a service changes, and this changed situation then serves as a condition for triggering an event and an operation according thereto of the UE and the base station, for example, transmitting a measurement report, performing a conditional handover, performing a conditional RACH-less handover, performing random access, etc.

Referring to FIG. 7, the base station may configure the events and conditions for triggering each of the events through a reference signal, for example, a synchronization sequence block (SSB) or a broadcasted system information block (SIB), or an RRC signal (e.g., an RRCReconfiguration message, etc.) (operation 720). The base station may provide such information also through a MAC signal, for example, a new MAC-CE, or a PHY signal, for example, a downlink control signal, etc. In FIG. 7, operations 710 and 720 may be separately described, but the operations 710 and 720 may be performed through the same message.

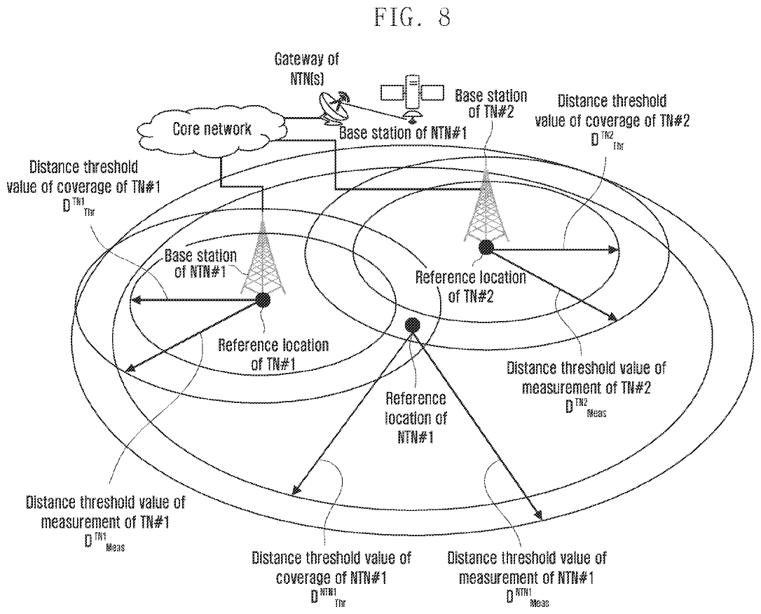

FIG. 8 illustrates various distance thresholds for a reference signal measurement operation of a UE according to various embodiments of the disclosure.

Referring to FIG. 8, the base station may define and configure various distance threshold values for the UE for the purpose of controlling a reference signal measurement operation of the UE, in addition to reference locations of the terrestrial network and the non-terrestrial network adjacent to the UE and the distance thresholds by which service areas can be inferred.

Here, an area in which a reference signal of TN #i needs to be measured to access terrestrial network cell TN #i is represented as

$${D}_{Mea}^{TNi} \text{?}$$

$$\text{?} \text{indicates text missing or illegible when filed}$$

corresponding to a relative distance threshold value from a reference location of TN #i. An area in which a reference signal of NTN #i needs to be measured to access a non-terrestrial network cell NTN #i is represented as

$${D}_{Meas}^{NTNi}$$

corresponding to a relative distance threshold value from a reference location of NTN #i.

$${D}_{Mea}^{TNi} \text{?} and {D}_{Meas}^{NTNi}$$

$$\text{?} \text{indicates text missing or illegible when filed}$$

may be a value configured for the UE by the base station, and may be values obtained by adding distance constants

$${D}_{cons}^{TNi} \text{?} and {D}_{const}^{NTNi}$$

$$\text{?} \text{indicates text missing or illegible when filed}$$

to coverage threshold values

$${D}_{Thr}^{TN} and {D}_{Thr}^{NTNi} ,$$

respectively, e.g.,

$${D}_{Meas}^{TNi} = {D}_{Thr}^{TNi} + {D}_{const}^{TNi} and {D}_{Meas}^{NTNi} = {D}_{Thr}^{NTNi} + {D}_{const}^{NTNi} .$$

The threshold value and the distance may be a positive number or a negative number.

A threshold value such as

$${D}_{Mea}^{TNi} \text{?} , {D}_{Meas}^{NTNi} , {D}_{cons}^{TNi} \text{?} , or {D}_{const}^{NTNi}$$

$$\text{?} \text{indicates text missing or illegible when filed}$$

may be configured for the UE by the base station through a reference signal, for example, a synchronization sequence block (SSB) or a broadcasted system information block (SIB), or an RRC signal, for example, an RRCReconfiguration message, etc. according to the procedure in FIG. 7. The base station may provide such information also through a MAC signal, for example, a new MAC-CE, or a PHY signal, for example, a downlink control signal, etc. In addition, a threshold value such as

$${D}_{Mea}^{TNi} \text{?} , {D}_{Meas}^{NTNi} , {D}_{cons}^{TNi} \text{?} , or {D}_{const}^{NTNi}$$

$$\text{?} \text{indicates text missing or illegible when filed}$$

may be may be pre-input information the UE has known from the manufacture.

In such an environment the UE may determine a specific location through reference locations of an adjacent terrestrial network and non-terrestrial network and reference locations or distance thresholds by which service areas can be inferred, and through the determination, may turn on or off reference signal measurement or increase or reduce a measurement period. For example:
In case that the UE is present within the distance of

$${D}_{Mea}^{TNi} \text{?}$$

$$\text{?} \text{indicates text missing or illegible when filed}$$

from TN cell i (e.g., in case that a TN cell ID is i), the UE may determine the same as follows, and perform an operation of turning on measurement of a reference signal of a corresponding TN cell i, all TN cells, or all cells or reducing a measurement period so as to effectively support mobility.

$$( {d}_{UE}^{TNi} + {Hys}_{i} < {D}_{Meas}^{TNi} ) :$$

Case where the distance between the UE and TN cell I is within configured threshold value

$$( {d}_{UE}^{TNi} + {Hys}_{i} < {D}_{Meas}^{TNi} ) \& ( {d}_{UE}^{NTNj} + {Hys}_{j} < {D}_{Thr}^{NTNj} ) :$$

Case where the distance between the UE and TN cell i is within a configured threshold value, and is also present within coverage of NTN cell j

$$( {d}_{UE}^{TNi} + {Hys}_{i} < {D}_{Meas}^{TNi} ) \& ( {d}_{UE}^{NTNj} + {Hys}_{j} < {D}_{Meas}^{NTNj} ) :$$

Case where the distance between the UE and TN cell i is within a configured threshold value and is also present within a threshold value of NTN cell j
In case that the UE does not belong to the vicinity of any TN cell, the UE may determine the same as follows, and perform an operation of turning off measurement of a reference signal of all TN cells or all cells or increasing a measurement period so as to save power.

$${∀}_{i} ( {d}_{UE}^{TNi} + {Hys}_{i} < {D}_{Meas}^{TNi} ) :$$

Case where the distance between the UE and all TN cells is out of a configured threshold value

$${∀}_{i} ( {d}_{UE}^{TNi} + {Hys}_{i} < {D}_{Meas}^{TNi} ) \& ( {d}_{UE}^{NTNj} + {Hys}_{j} < {D}_{Thr}^{NTNj} ) :$$

Case where the distance between the UE and all TN cells is out of a configured threshold value, and is also present within coverage of NTN cell j

$${∀}_{i} ( {d}_{UE}^{TNi} + {Hys}_{i} < {D}_{Meas}^{TNi} ) \& ( {d}_{UE}^{NTNj} + {Hys}_{j} < {D}_{Meas}^{NTNj} ) :$$

Case where the distance between the UE and all TN cells is out of a configured threshold value, and is also present within a threshold value of NTN cell j

Hysᵢ, Hysⱼ in the description above may be a hysteresis value for determination, configured by the network, and may have the same unit as the distance.
i. The LUE may compare a distance threshold value of each cell with the distance between the UE and a reference location of each cell so as to trigger an event.
1.

$${∀}_{i} ( {d}_{UE}^{TNi} + {Hys}_{i} < {D}_{Thr}^{TNi} ) \& ( {d}_{UE}^{NTNj} + {Hys}_{j} < {D}_{Thr}^{NTNj} )$$

ii. The UE may compare the distance threshold value of each cell, the distance between the UE and the reference location of each cell, an absolute location (R_{UE}) of the UE, and an absolute area (Area^{TNi}) of each cell, derived through a service area vertex reference location list of each cell, so as to trigger an event. Here, the absolute area (Area^{TNi}) of each cell is a polygon drawn by straight lines having the service area vertex reference positions of each cell as vertices.
1.

$${∀}_{i} ( {R}_{UE} ∈ {Area}^{TNi )} \& ( {d}_{UE}^{NTNj} + {Hys}_{j} < {D}_{Thr}^{NTNj} )$$

Additionally, the UE may simultaneously consider the following event trigger conditions according to signal strength measurement, for example, in a case where the base station configures one or more conditions among the location-based conditions above and the signal strengths measurement conditions below, in case that all the conditions are satisfied, the UE may trigger an event.
i. A2: Case where a reception signal strength of a terrestrial network serving cell is equal to or below a predetermined threshold value configured by the base station
   1. Ms+Hys<Thresh
      A. Ms is the measurement result of the serving cell, not taking into account any offsets.
      B. Hys is the hysteresis parameter for this event (i.e. hysteresis as defined within reportConfigNR for this event).
      C. Thresh is the threshold parameter for this event (i.e. a2-Threshold as defined within reportConfigNR for this event).
      D. Ms is expressed in dBm in case of RSRP, or in dB in case of RSRQ and RS-SINR.
      E. Hys is expressed in dB.
      F. Thresh is expressed in the same unit as Ms.
ii. A2′: Case where reception signal strengths of all terrestrial cells are equal to or below a predetermined threshold value configured by the base station

$$\begin{matrix}2. & {∀}_{i}\end{matrix} Ms ( i ) + Hys < Thresh$$

G. Ms(s) is the measurement result of the cell i, not taking into account any offsets.
H. Hys is the hysteresis parameter for this event (i.e. hysteresis as defined within reportConfigNR for this event).
I. Thresh is the threshold parameter for this event (i.e. a2-Threshold as defined within reportConfigNR for this event).
J. Ms is expressed in dBm in case of RSRP, or in dB in case of RSRQ and RS-SINR.
K. Hys is expressed in dB.
L. Thresh is expressed in the same unit as Ms.
iii. A1′: Case where a reception signal strength of a non-terrestrial network (NT) cell is equal to or below a predetermined threshold value configured by the base station

$$3. \qquad Ms ( j ) - Hys > Thresh$$

M. Ms(j) is the measurement result of the cell j, not taking into account any offsets.
N. Hys is the hysteresis parameter for this event (i.e. hysteresis as defined within reportConfigNR for this event).
O. Thresh is the threshold parameter for this event (i.e. a2-Threshold as defined within reportConfigNR for this event).
P. Ms is expressed in dBm in case of RSRP, or in dB in case of RSRQ and RS-SINR.
Q. Hys is expressed in dB.
R. Thresh is expressed in the same unit as Ms.
iv. A3′: Case where a reception signal strength of an adjacent non-terrestrial network (NTN) cell is equal to or above a predetermined threshold value configured by the base station, compared to the reception signal strength of the terrestrial network serving cell

$$Mn + Ofn + Ocn - Hys > Mp + Ofp + Ocp + Off \qquad 4.$$

S. Mn is the measurement result of the neighbouring (NTN) cell, not taking into account any offsets.
T. Ofn is the measurement object specific offset of the reference signal of the neighbour (NTN) cell (i.e. offsetMO as defined within measObjectNR corresponding to the neighbour cell).
U. Ocn is the cell specific offset of the neighbour (NTN) cell (i.e. cellIndividualOffset as defined within measObjectNR corresponding to the frequency of the neighbour cell), and set to zero if not configured for the neighbour cell.
V. Mp is the measurement result of the (TN) SpCell, not taking into account any offsets.
W. Ofp is the measurement object specific offset of the (TN) SpCell (i.e. offsetMO as defined within measObjectNR corresponding to the SpCell).
X. Ocp is the cell specific offset of the (EN) SpCell (i.e. cellIndividualOffset as defined within measObjectNR corresponding to the SpCell), and is set to zero if not configured for the SpCell.
Y. Hys is the hysteresis parameter for this event (i.e. hysteresis as defined within reportConfigNR for this event).
Z. Off is the offset parameter for this event (i.e. a3-Offset as defined within reportConfigNR for this event).
AA. Mn, Mp are expressed in dBm in case of RSRP, or in dB in case of RSRQ and RS-SINR.
BB. Ofh, Ocn, Ofp, Ocp, Hys, Off are expressed in dB.
v. A3″: Case where a reception signal strength of an adjacent non-terrestrial network (NTN) cell is equal to or above a predetermined threshold value configured by the base station, compared to the configured reception signal strengths of all terrestrial network serving cells

$$Mn + Ofn + Ocn - Hys > Mp ( i ) + Ocp ( i ) + Off \qquad 5.$$

CC. Mn is the measurement result of the neighbouring (NTN) cell, not taking into account any offsets.
DD. Ofn is the measurement object specific offset of the reference signal of the neighbour (NTN) cell (i.e. offsetMO as defined within measObjectNR corresponding to the neighbour cell).
EE. Ocn is the cell specific offset of the neighbour (NTN) cell (i.e. cellIndividualOffset as defined within measObjectNR corresponding to the frequency of the neighbour cell), and set to zero if not configured for the neighbour cell.
FF. Mp(i) is the measurement result of the (TN) SpCell i, not taking into account any offsets.
GG. Ofp(i) is the measurement object specific offset of the (TN) SpCell i (i.e. offsetMO as defined within measObjectNR corresponding to the SpCell).
HH. Ocp(i) is the cell specific offset of the (TN) SpCell i (i.e. cellIndividualOffset as defined within measObjectNR corresponding to the SpCell), and is set to zero if not configured for the SpCell.
II. Hys is the hysteresis parameter for this event (i.e. hysteresis as defined within reportConfigNR for this event).
JJ. Off is the offset parameter for this event (i.e. a3-Offset as defined within reportConfigNR for this event).
KK. Mn, Mp are expressed in dBm in case of RSRP, or in dB in case of RSRQ and RS-SINR.
LL. Ofh, Ocn, Ofp, Ocp, Hys, Off are expressed in dB.
B. Additionally, the UE may simultaneously consider the following event trigger conditions according to time measurement, for example, in a case where the base station configures one or more conditions among the location-based conditions, signal strengths measurement conditions, and time measurement conditions above, in case that all the conditions are satisfied, the UE may trigger an event.
i. T1: Case where the time of the UE is equal to or greater than a predetermined threshold value configured by the base station
   1. Mt>Thresh1
      A. Mt is the time measured at UE
      B. Thresh1 is the threshold parameter for this event (i.e. t1-Threshold as defined within reportConfigNR for this event).
      C. Duration is the duration parameter for this event (i.e. duration as defined within reportConfigNR for this event).
      D. Mt is expressed in ms.
      E. Thresh1 is expressed in the same unit as Mt.
      F. Duration is expressed in the same unit as Mt.
ii. T1′: Case where the time of the UE is equal to or less than a predetermined threshold value configured by the base station
   1. Mt<Thresh1
      A. Mt is the time measured at UE.
      B. Thresh1 is the threshold parameter for this event (i.e. t1-Threshold as defined within reportCongfigNR for this event).
      C. Duration is the duration parameter for this event (i.e. duration as defined within reportConfigNR for this event).
      D. Mt is expressed in ms.
      E. Thresh1 is expressed in the same unit as Mt.
      F. Duration is expressed in the same unit as Mt.
C. The UE may determine various events that can be supported by the UE and the standard, for example, event A according to signal strength measurement, event B by inter-Rat measurement, or event I by interference measurement, and various events, in addition to the above-described event determination condition, and may trigger an event. The condition of the event may be configured by the base station.
2. Through the location condition determination below, the UE may trigger an event, for example, an event such as transmitting a measurement report, performing a conditional handover to a terrestrial network, performing a conditional RACH-less handover to a terrestrial network, and performing random access to a terrestrial network.
A. The UE may determine that the UE is included in a service area of terrestrial network (TN) cell i as follows, and trigger an event.
i. The UE may compare the distance threshold value of each cell with the distance between the UE and the reference location of each cell so as to trigger an event.
   1. Find “i” satisfying

$${i}_{} ( {d}_{UE}^{TNi} + Hys < {D}_{Thr}^{TNi} )$$

and trigger an event for all “i”s
2. Find “i” satisfying

$${i}_{} ( {d}_{UE}^{TNi} + Hys < {D}_{Thr}^{TNi} ) ,$$

and in case that there are one or more “i”s, additionally determine the following conditions
   A. Select “i” having the smallest

$${d}_{UE}^{TNi}$$

and trigger an event
B. Select “i” having the best reception signal strength performance (having the largest RSRP, RSRQ, RSSI, CQI, SINR, or SNR) and trigger an event
ii. The UE may compare the distance threshold value of each cell, the distance between the UE and the reference location of each cell, an absolute location (R_{UE}) of the UE, and an absolute area (Area^{TNi}) of each cell, derived through a service area vertex reference location list of each cell, so as to trigger an event. Here, the absolute area (Area^{TNi}) of each cell is a polygon drawn by straight lines having the service area vertex reference positions of each cell as vertices.
   1. Find “i” satisfying [symbol] [symbol] (R_{UE}ϵArea^{TNi}) and trigger an event for all “i”s
   2. Find “i” satisfying [symbol] [symbol] (R_{UE}ϵArea^{TNi}), and in case that there are one or more “i”s, additionally determine the following conditions
      A. Select “i” having the smallest

$${d}_{UE}^{TNi}$$

and trigger an event
B. Select “i” having the best reception signal strength performance (having the largest RSRP,RSRQ, RSSI, CQI, SINR or SNR) and trigger an event
B. Additionally, the UE may simultaneously consider the following event trigger conditions according to signal strength measurement, for example, in a case where the base station configures one or more conditions among the location-based conditions above and the signal strengths measurement conditions below, in case that all the conditions are satisfied, the UE may trigger an event.
i. A2: Case where a reception signal strength of a non-terrestrial network serving cell is equal to or below a predetermined threshold value configured by the base station

$$\begin{matrix}1. & Ms + Hys\end{matrix} < Thresh$$

A. My is the measurement result of the serving cell, not taking into account any offsets.
B. Hys is the hysteresis parameter for this event (i.e. hysteresis as defined within reportConfigNR for this event).
C. Thresh is the threshold parameter for this event (i.e. a2-Threshold as defined within reportConfigNR for this event)
D. My is expressed in dBm in case of RSRP, or in dB in case of RSRQ and RS-SINR.
E. Hys is expressed in dB.
F. Thresh is expressed in the sane unit as Is.
ii. A1′: Case where a reception signal strength of a terrestrial network (TN) cell is equal to or above a predetermined threshold value configured by the base station

$${\begin{matrix}1. & ∃\end{matrix}}_{i} ( Ms ( i ) - Hys > Thresh )$$

A. Ms(j) is the measurement result of the cell j, not taking into account any offsets.
B. Hys is the hysteresis parameter for this event (i.e. hysteresis as defined within reportConfigNR for this event).
C. Thresh is the threshold parameter for this event (i.e. a2-Threshold as defined within reportConfigNR for this event).
D. A is expressed in dBm in case of RSRP, or in dB in case of RSRQ and RS-SINR.
E. Hys is expressed in dB.
F. Thresh is expressed in the same unit as Ms.
iii. A3′: Case where a reception signal strength of an adjacent terrestrial network (TN) cell is equal to or above a predetermined threshold value configured by the base station, compared to a reception signal strength of a non-terrestrial network service cell

$$Mn + Ofn + Ocn - Hys > Mp + Ofp + Ocp + Off \qquad 1.$$

A. Mn is the measurement result of the neighbouring (TN) cell, not taking into account any offsets.
B. Ofh is the measurement object specific offset of the reference signal of the neighbour (TN) cell (i.e. offsetMO as defined within measObjectNR corresponding to the neighbour cell).
C. Ocn is the cell specific offset of the neighbour (TN) cell (i.e. cellIndividualOffset as defined within measObjectNR corresponding to the frequency of the neighbour cell), and set to zero if not configured for the neighbour cell.
D. Mp is the measurement result of the (NTN) SpCell, not taking into account any offsets.
E. Ofp is the measurement object specific offset of the (NTN) SpCell (i.e. offsetMO as defined within measObjectNR corresponding to the SpCell).
F. Ocp is the cell specific offset of the (NTN) SpCell (i.e. cellIndividualOffset as defined within measObjectNR corresponding to the SpCell), and is set to zero if not configured for the SpCell.
G. Hys is the hysteresis parameter for this event (i.e. hysteresis as defined within reportConfigNR for this event).
H. Off is the offset parameter for this event (i.e. a3-Offset as defined within reportConfigNR for this event).
I. Mn, Mp are expressed in dBm in case of RSRP, or in dB in case of RSRQ and RS-SINR.
J. Ofn, Ocn, Ofp, Ocp, Hys, Off are expressed in dB.
C. Additionally, the UE may simultaneously consider the following event trigger conditions according to time measurement, for example, in a case where the base station configures one or more conditions among the location-based conditions, signal strengths measurement conditions, and time measurement conditions above, in case that all the conditions are satisfied, the UE may trigger an event,
i. T1: Case where the time of the UE is equal to or greater than a predetermined threshold value configured by the base station
   1. Mt>Thresh1
      A. Mt is the time measured at UE.
      B. Thresh1 is the threshold parameter for this event (i.e. t1-Threshold as defined within reportConfigNR for this event).
      C. Duration is the duration parameter for this event (i.e. duration as defined within reportConfigNR for this event).
      D. Mt is expressed in mis.
      F. Thresh1 is expressed in the same unit as Mt.
      F. Duration is expressed in the same unit as Mt.
ii. T1′: Case where the time of the UE is equal to or below a predetermined threshold value configured by the base station
1. Mt<Thresh1
   A. Mt is the time measured at UE.
   B. Thresh1 is the threshold parameter for this event (i.e. t1-Threshold as defined within reportConfigNR for this event).
   C. Duration is the duration parameter for this event (i.e. duration as defined within reportConfigNR for this event).
   D. Mt is expressed in mis.
   E. Thresh1 is expressed in the same unit as Mt.
   F. Duration is expressed in the same unit as Mt.
D. The UE may determine various events that can be supported by the UE and the standard, for example, event A according to signal strength measurement, event B by inter-Rat measurement, or event I by interference measurement, and various events, in addition to the above-described event determination condition, and may trigger an event. The condition of the event may be configured by the base station.

The inequality signs, including the inequality and equality signs used in any embodiment proposed in the disclosure, can be interchangeably replaced. For example, > may be replaced by ≥, < may be replaced by ≤, ≥ may be replaced by >, and ≤ may be replaced by <.

In various embodiments of the disclosure, it is described that the UE determines an event condition and performs a reference signal measurement relaxation operation or a power saving operation. This may include not only determining an event condition by the UE and immediately preforming the corresponding operation, but also determining, by the LUE, whether the event condition is satisfied and performing, based on indication or signaling from the base station, the reference signal measurement relaxation operation or the power saving operation in case that the event satisfaction is reported to the base station.

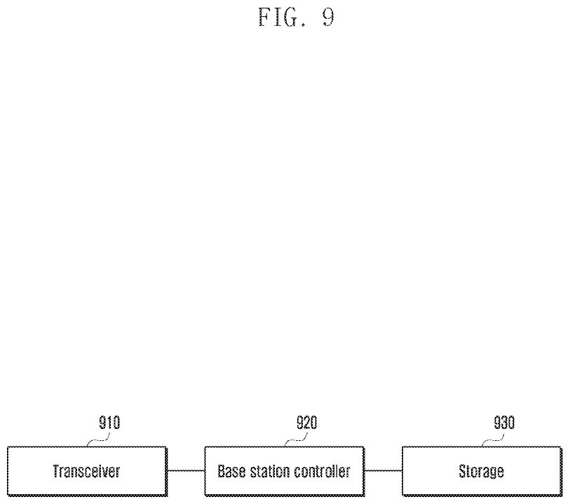

FIG. 9 illustrates a structure of a base station according to an embodiment of the disclosure.

Referring to FIG. 9, the base station may include a transceiver 910, a controller 920, and a storage 930. The transceiver 910, the controller 920, and the storage 930 may be operated according to the above-described communication methods of the base station. In addition, a network device may also correspond to the structure of the base station. However, components of the base station are not limited to the above-described example. For example, the base station may include a larger or smaller number of components than the above-described components. For example, the base station may include the transceiver 910 and the controller 920. Furthermore, the transceiver 910, the controller 920, and the storage 930 may be implemented in the form of a single chip.

The transceiver 910 refers to a base station receiver and a base station transmitter as a whole, and may transmit/receive signals with UEs, other base stations, and other network devices. The transmitted/received signals may include control information and data. The transceiver 910 may transmit, for example, system information, synchronization signals, or reference signals to the UE. To this end, the transceiver 910 may include a radio frequency (RF) transmitter configured to up-convert and amplify the frequency of transmitted signals, an RF receiver configured to low-noise-amplify received signals and down-convert the frequency thereof, and the like. However, this is only an embodiment of the transceiver 910, and the components of the transceiver 910 are not limited to the RF transmitter and the RF receiver. The transceiver 910 may include wired/wireless transceivers, and may include various components for transmitting/receiving signals. In addition, the transceiver 910 may receive signals through a communication channel (e.g., a radio channel), output the same to the controller 920, and transmit signals output from the controller 920 through the communication channel. Furthermore, the transceiver 910 may receive communication signals, output same to a processor, and transmit signals output from the processor to the UE, other base stations, or other network entities through a wired/wireless network.

The storage 930 may store programs and data necessary for operations of the base station. In addition, the storage 930 may store control information or data included in signals acquired by the base station. The storage 930 may include storage media such as a ROM, a RAM, a hard disk, a CD-ROM, and a DVD, or a combination of storage media. In addition, the storage 930 may store at least one of information transmitted/received through the transceiver 910 and information generated through the controller 920.

As used herein, the controller 920 may be defined as a circuit, an application specific integrated circuit, or at least one processor. The processor may include a communication processor (CP) which performs control for communication and an application processor (AP) which controls upper layers such as application programs. The controller 920 may control the overall operation of the base station according to the embodiments proposed in the disclosure. For example, the controller 920 may control signal flows between the respective blocks to perform operations according to the above-described flowcharts.

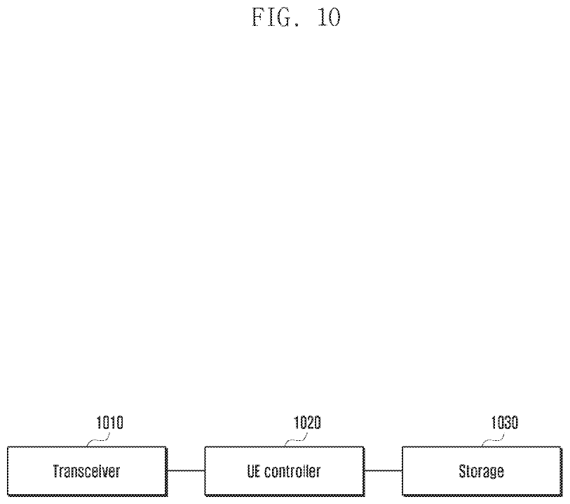

FIG. 10 illustrates a structure of a UE according to an embodiment of the disclosure.

Referring to FIG. 10, the UE may include a transceiver 1010, a controller 1020, and a storage 1030. The transceiver 1010, the controller 1020, and the storage 1030 may be operated according to the above-described communication methods of the UE. Components of the UE are not limited to the above-described example. For example, the UE may include a larger or smaller number of components than the above-described components. For example, the UE may include the transceiver 1010 and the controller 1020, Furthermore, the transceiver 1010, the controller 1020, and the storage 1030 may be implemented in the form of a single chip.

The transceiver 1010 refers to a UE receiver and a UE transmitter as a whole, and may transmit/receive signals with base stations, other UEs, and other network entities. The signals transmitted/received with the base station may include control information and data. The transceiver 1010 may receive, for example, system information, synchronization signals, or reference signals from the base station. To this end, the transceiver 1010 may include an IF transmitter configured to up-convert and amplify the frequency of transmitted signals, an RF receiver configured to low-noise-amplify received signals and down-convert the frequency thereof, and the like. However, this is only an embodiment of the transceiver 1010, and the components of the transceiver 1010 are not limited to the RF transmitter and the RF receiver. Also, the transceiver 1010 may include wired/wireless transceivers, and may include various components for transmitting/receiving signals. In addition, the transceiver 1010 may receive signals through a radio channel, output the same to the controller 1020, and transmit signals output from the controller 1020 through the radio channel. Furthermore, the transceiver 1010 may receive communication signals, output same to a processor, and transmit signals output from the processor to a network entity through a wired/wireless network.

The storage 1030 may store programs and data necessary for operations of the IE. In addition, the storage may store control information or data included in a signal acquired by the UE. The storage 1030 may include storage media such as a ROM, a RAM, a hard disk, a CD-ROM, and a DVD, or a combination of storage media.

As used herein, the controller 1020 may be defined as a circuit, an application specific integrated circuit, or at least one processor. The processor may include a communication processor (CP) which performs control for communication and an application processor (AP) which controls upper layers such as application programs. The controller 1020 may control the overall operation of the UE according to the embodiments proposed in the disclosure. For example, the controller 1020 may control signal flows between the respective blocks to perform operations according to the above-described flowcharts.

Methods disclosed in the claims and/or methods according to the embodiments described in the specification of the disclosure may be implemented by hardware, software, or a combination of hardware and software.

In case that the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method of a terminal in a wireless communication system, the method comprising:
receiving, from a base station of a non-terrestrial network, reference location information of a cell operated by the base station;
determining whether a trigger condition for performing an operation for a power saving is satisfied, based on the reference location information; and
in case that the trigger condition is satisfied, performing the operation for the power saving.

2. The method of claim 1, wherein at least one of a first condition based on a mobility of the terminal or a second condition based on a location of the terminal within the cell is configured as the trigger condition from the base station.

3. The method of claim 2, wherein the first condition corresponds to determining a low mobility of the terminal, based on the reference location information, the location of the terminal, and first threshold value information.

4. The method of claim 2, wherein the second condition corresponds to determining whether the terminal is located at an edge of the cell, based on the reference location information, the location of the terminal, and second threshold value information.

5. The method of claim 1, wherein the operation for the power saving comprises at least one of an operation of increasing a radio resource management (RRM) measurement period or an operation of increasing a radio link monitoring (RLM) monitoring period.

6. The method of claim 2, wherein at least one of the first condition or the second condition is determined by further considering a reference signal received power (RSRP) or a reference signal received quality (RSRQ) measured by the terminal.

7. The method of claim 6, wherein, in case that the terminal satisfies a low mobility condition and a synchronization signal-reference signal received power (SS-RSRP)-based signal strength condition of a serving cell, a measurement relaxation operation for the power saving is performed.

8. The method of claim 1, wherein the reference location information corresponds to a value changing over time.

9. A terminal of a wireless communication system, the terminal comprising:
a transceiver; and
a controller,
wherein the controller is configured to:
receive, from a base station of a non-terrestrial network, reference location information of a cell operated by the base station;
determine whether a trigger condition for performing an operation for a power saving is satisfied, based on the reference location information; and
in case that the trigger condition is satisfied, control the terminal to perform the operation for the power saving.

10. The terminal of claim 9, wherein at least one of a first condition based on a mobility of the terminal or a second condition based on a location of the terminal within the cell is configured as the trigger condition from the base station.

11. The terminal of claim 10, wherein the first condition corresponds to determining a low mobility of the terminal, based on the reference location information, the location of the terminal, and first threshold value information.

12. The terminal of claim 10, wherein the second condition corresponds to determining whether the terminal is located at an edge of the cell, based on the reference location information, the location of the terminal, and second threshold value information.

13. The terminal of claim 9, wherein the operation for the power saving comprises at least one of an operation of increasing a radio resource management (RRM) measurement period or an operation of increasing a radio link monitoring (RLM) monitoring period.

14. The terminal of claim 10, wherein at least one of the first condition or the second condition is determined by further considering a reference signal received power (RSRP) or a reference signal received quality (RSRQ) measured by the terminal, and
wherein, in case that the terminal satisfies a low mobility condition and a synchronization signal-reference signal received power (SS-RSRP)-based signal strength condition of a serving cell, a measurement relaxation operation for the power saving is performed.

15. The terminal of claim 9, wherein the reference location information corresponds to a value changing over time.
